(19) United States
(12) Patent Application Publication
(10) Pub. No.: US 2026/0020612 A1
(43) Pub. Date: Jan. 22, 2026

(54) AEROSOL PROVISION DEVICE

(71) Applicant: NICOVENTURES TRADING LIMITED, London (GB)

(72) Inventors: Michael THOMAS, London (GB); Zheng XIAOYUAN, Longgang District (CN)

(21) Appl. No.: 18/996,161

(22) PCT Filed: Jul. 20, 2023
(86) PCT No.: PCT/EP2023/070180

§ 371 Date: Jan. 17, 2025

(30) Foreign Application Priority Data
Jul. 21, 2022 (CN) 202210868156.6
Aug. 3, 2022 (GB) 2211346.8

(51) Int. Cl. A24F 40/46; A24F 40/20; H05B 3/22

(52) U.S. Cl. CPC A24F 40/46; A24F 40/20; H05B 3/22

(57) ABSTRACT

An aerosol provision device including a main housing having a heating element which projects within the main housing. The device further includes a receptacle arranged around the heating element and arranged to receive an aerosol generating article, the receptacle having one or more external projections. The device also includes a rotatable tube having one or more helical tracks, wherein the one or more projections on the receptacle engage with the one or more helical tracks, and wherein in use the rotatable tube may be rotated in order to translate the receptacle relative to the heating element so as to remove or at least partially remove an aerosol generating article from the heating element.

### RELATED APPLICATIONS

The present application is a National Phase entry of PCT Application No. PCT/EP2023/070180 filed Jul. 20, 2023, which claims priority to CN Application No. 202210868156.6 filed Jul. 21, 2022 and GB Application No. 2211346.8 filed Aug. 3, 2022, each of which is hereby incorporated by reference in their entirety.

### TECHNICAL FIELD

The present invention relates to an aerosol provision device and an aerosol provision system.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation.

It is known to use a resistive heater to create aerosol from a suitable medium.

Conventional aerosol provision devices comprise a cylindrical heating chamber into which a rod shaped consumable is inserted.

One problem with known aerosol provision devices is that an aerosol generating article can become stuck on a heating element.

It is desired to provide an improved aerosol provision device.

### SUMMARY

According to an aspect there is provided an aerosol provision device comprising:
a main housing comprising a heating element which projects within the main housing;
a receptacle arranged around the heating element and arranged to receive an aerosol generating article, the receptacle having one or more external projections; and
a rotatable tube having one or more helical tracks, wherein the one or more projections on the receptacle engage with the one or more helical tracks, and wherein in use the rotatable tube may be rotated in order to translate the receptacle relative to the heating element so as to remove or at least partially remove an aerosol generating article from the heating element.

Known aerosol provision devices comprising a heater element suffer from the problem that an aerosol generating article may become stuck to the heater element in use. The aerosol provision device according to various embodiments is particularly beneficial in that a receptacle sits around the aerosol generating article and may be translated relative to the heating element by rotation of the rotatable tube. This facilitates the removal of an aerosol generating article from the heating element.

Optionally, the receptacle is translatable between a first position in which the receptacle is fully advanced into the main housing and a second position in which the receptacle is at least partially advanced out of the main housing.

Optionally, the receptacle comprises a base portion comprising an aperture through which heating element passes, and wherein when moving from the first position to the second position, the base portion of the receptacle moves towards a free end of the heating element.

Optionally, in the second position the base portion of the receptacle is past the free end of the heating element.

Optionally, the aerosol provision device further comprises a tubular cover arranged to cover the rotatable tube, and wherein the tubular cover is arranged to engage the rotatable tube such that, in use, rotation of the tubular cover drives rotation of the rotatable tube.

Optionally, the receptacle is translatable between a first position in which the receptacle is fully contained within the tubular cover and a second position in which the receptacle protrudes from an open end of the tubular cover.

Optionally, the receptacle is translatable in a longitudinal direction of the aerosol provision device.

Optionally, the tubular cover is configured to be sleeved onto the rotatable tube.

Optionally, the tubular cover may have a truncated circular cross-sectional profile comprising a first arcuate section having a curved outer surface and a second linear section having a planar outer surface.

Optionally, an outer dimension of the receptacle may substantially correspond to an inner dimension of the rotatable tube.

Optionally, the one or more projections may comprise a first projection and a second projection, wherein the one or more helical tracks may comprise a first helical track and a second helical track, and wherein the first projection is arranged to engage with the first helical track and the second projection is arranged to engage with the second helical track.

Optionally, the second projection is located on an opposite side of the receptacle to the first projection.

Optionally, the one or more projections each comprise a circular cross-sectional profile.

Optionally, the receptacle is cylindrical and the rotatable tube is cylindrical.

Optionally, the rotatable tube comprises one or more retention elements arranged to engage a tubular cover arranged to cover the rotatable tube.

Optionally, each of the one or more retention elements are resiliently biased such that they engage the tubular cover.

Optionally, each of the one or more retention elements comprises a chamfered portion arranged to allow the tubular cover to pass over the retention element during assembly of the aerosol provision device.

Optionally, the receptacle comprises a first alignment feature and the main housing comprises a second alignment feature, and wherein the first alignment feature is arranged to engage the second alignment feature.

Optionally, the first alignment feature is arranged to engage the second alignment feature when the receptacle is fully advanced into the main housing.

Optionally, one of the first alignment feature or second alignment feature comprises an alignment protrusion and wherein the other of the first alignment feature or second alignment feature comprises a cut-away shaped to receive the alignment protrusion.

According to another aspect there is provided an aerosol provision system comprising:
an aerosol provision device as described above; and
an aerosol generating article for insertion into the aerosol provision device.

### BRIEF DESCRIPTION OF THE DRAWINGS

Various embodiments will now be described, by way of example only, and with reference to the accompanying drawings in which:

FIG. 1 shows an aerosol provision device located within a charging unit according to an embodiment;

FIG. 2 shows a cross-sectional view of an aerosol provision device located within a charging unit;

FIG. 3 shows a perspective view of a receptacle and a rotatable tube of an aerosol provision device in accordance with an embodiment;

FIG. 4 shows the rotatable tube shown in FIG. 3 in isolation;

FIG. 5 shows a focused view of a retention element of the rotatable tube shown in FIGS. 3 and 4;

FIG. 6 illustrates the assembly of the rotatable tube onto the receptacle;

FIG. 7 shows the assembly of a tubular cover onto the assembled receptacle and rotatable tube; and

FIG. 8 shows a perspective view of an embodiment focusing on the engagement of the first and second alignment features.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

For completeness, aerosol provision devices comprising an inductive element are known. The aerosol provision device may comprise one or more inductors and a susceptor which is arranged to be heated by the one or more inductors.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Various embodiments will now be described in more detail.

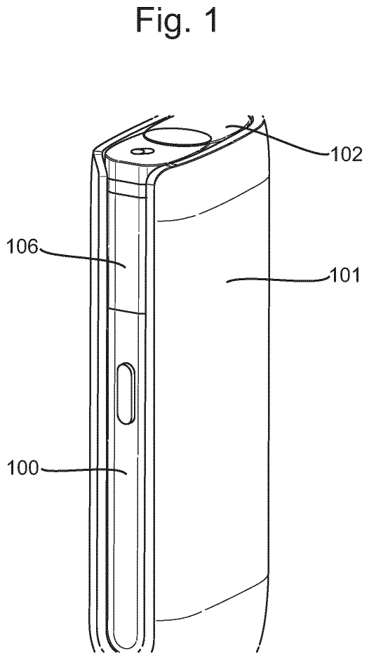

FIG. 1 shows an aerosol provision device 100 according to an embodiment shown located within an elongate cavity of a charging unit 101. The charging unit 101 may comprise a power source (not shown). The power source may include, for example, a battery (single-use or rechargeable), a rechargeable super capacitor, a rechargeable solid-state battery (SSB), a rechargeable lithium-ion battery (LiB) or the like, a hermetically sealed battery, a pouch cell battery or some combination thereof. Whilst the aerosol provision device 100 is shown in combination with a charging unit 101, it will be appreciated that the aerosol provision device 100 may be provided with power by any other means. For example, a power source provided with aerosol provision device 100 may be charged by plugging a power supply into the aerosol provision device 100, or the power source may be replaceable, e.g. in the form of a replaceable battery.

The aerosol provision device 100 may be left in the charging unit 101 for a predetermined time in order to allow sufficient charging of the aerosol provision device 100. For example, the charging unit 101 may be arranged to charge the aerosol provision device 100 to full charge in a time of <10 mins, 10-20 mins, 20-30 mins, 30-40 mins, 40-50 mins, 50-60 mins or >60 mins.

The charging unit 101 and/or the aerosol provision device 100 may optionally have an indicator to give a visual or other representation to the user of the charging level of the aerosol provision device 100. Additionally, there may be a separate indicator to give a visual representation of the charge level of the charging unit 101. The current charge level of the aerosol provision device 100 and/or the charging unit 101 may be determined by control means disposed in the aerosol provision device 100 and/or the charging unit 101.

The visual indicator may comprise one or more light-emitting diodes (LEDs). However, other embodiments are contemplated where the visual indicator may be replaced by an audio indicator (e.g. a speaker) or a haptic indicator.

The aerosol provision device 100 may comprise an outer housing which may have a tubular and/or cylindrical shape. However, other embodiments are envisaged wherein the aerosol provision device 100 may take other desired forms e.g. the aerosol provision device 100 may be boxed shaped. According to an embodiment the outer housing of the aerosol provision device 100 may comprise an electrical insulator and may, for example, be formed of polyether ether ketone (“PEEK”).

According to an embodiment the distal end of the aerosol provision device 100 may comprise one or more orientation features and/or one or more magnets for securing the distal end of the aerosol provision device 100 to a base portion of the charging unit 101.

The aerosol provision device 100 may be inserted into the cavity of the charging unit 101 in order to recharge the aerosol provision device 100 by receiving electrical power from the charging unit 101. The charging unit 101 may comprise an internal battery to provide electrical power to the aerosol provision device 100. The charging unit 101 may also be connected to an external source of electrical power.

The charging unit 101 may comprise a lid or cover 102 which may be slid by a user between an open and closed position. The lid or cover 102 is provided at the entrance to the cavity which is provided within the charging unit 101 and which is configured to receive the aerosol provision device 100.

The aerosol provision device 100 includes an aerosol generator for generating aerosol from aerosol generating material. According to an embodiment the aerosol provision device 100 comprises a resistive heater for heating an aerosol generating article.

When the lid or cover 102 is in the open position an opening to the cavity is exposed thereby enabling a user to either remove the aerosol provision device 100 from the charging unit 101 (in order to use the aerosol provision device 100) or alternatively to insert the aerosol provision device 100 into the charging unit 101 (in order to charge the aerosol provision device 100).

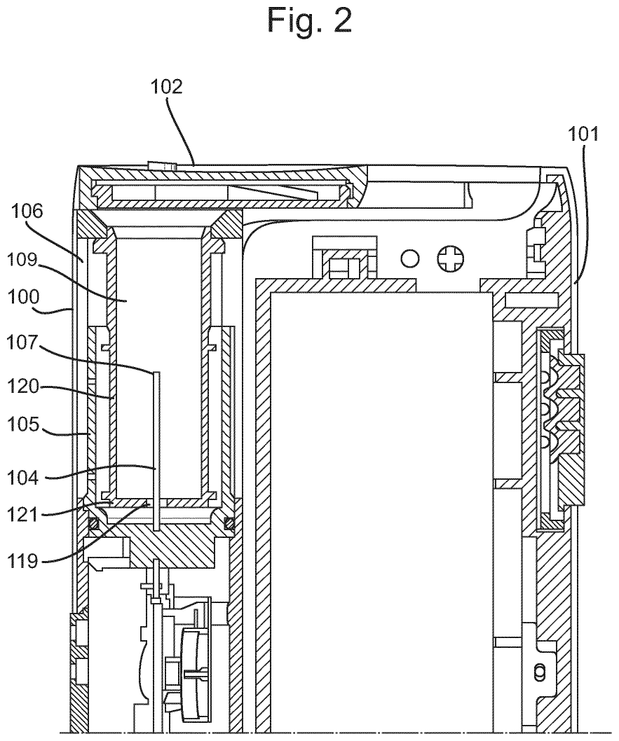

FIG. 2 shows a cross-sectional view showing the aerosol provision device 100 located or docked within the charging unit 101. The aerosol provision device 100 comprises a main housing 105 wherein a resistive heating element 104 projects within the main housing 105. The aerosol provision device 100 further comprises a removable cap 106 which may be magnetically retained to the main housing 105.

The removal cap 106 includes a receptacle 120 for receiving a consumable. In use, an aerosol generating article is inserted in the receptacle 120. The receptacle 120 comprises a tubular housing having a base portion 121. The base portion 121 of the receptacle 120 has an aperture 119 and the resistive heating element 104 is arranged to project through the aperture 119. An aerosol generating article may be inserted into the aerosol provision device 100 by inserting the aerosol generating article through an opening in the removable cap 106 and then inserting the aerosol generating article into the receptacle 120 and onto the heating element 104. The heating element 104 has a blade like profile and in use an aerosol generating article may be forced onto the heating element 104 so that the blade like profile of the heating element 104 inserts into a distal end of the aerosol generating article. The heating element 104 is arranged to internally heat the aerosol generating article.

The heating element 104 comprises a free end 107 which freely projects into a cavity 109 defined within the aerosol provision device 100.

At the end of a session of use, when an aerosol generating article has been consumed, the receptacle 120 may then be translated relative to the heating element 104 contained within the main housing 105. It will be understood that the process of translating the receptacle 120 will have the effect that the base portion 121 of the receptacle 120 will contact a bottom face of the aerosol generating article. As the receptacle 120 is translated relative to the heating element 104, then the base portion 121 of the receptacle 120 will contact the distal end of the aerosol generating article and will result in the aerosol generating article being pulled off or otherwise removed from the heating element 104. Translation of the receptacle 120 relative to the heating element 104, and the mechanism for driving this translation, is discussed in more detail below.

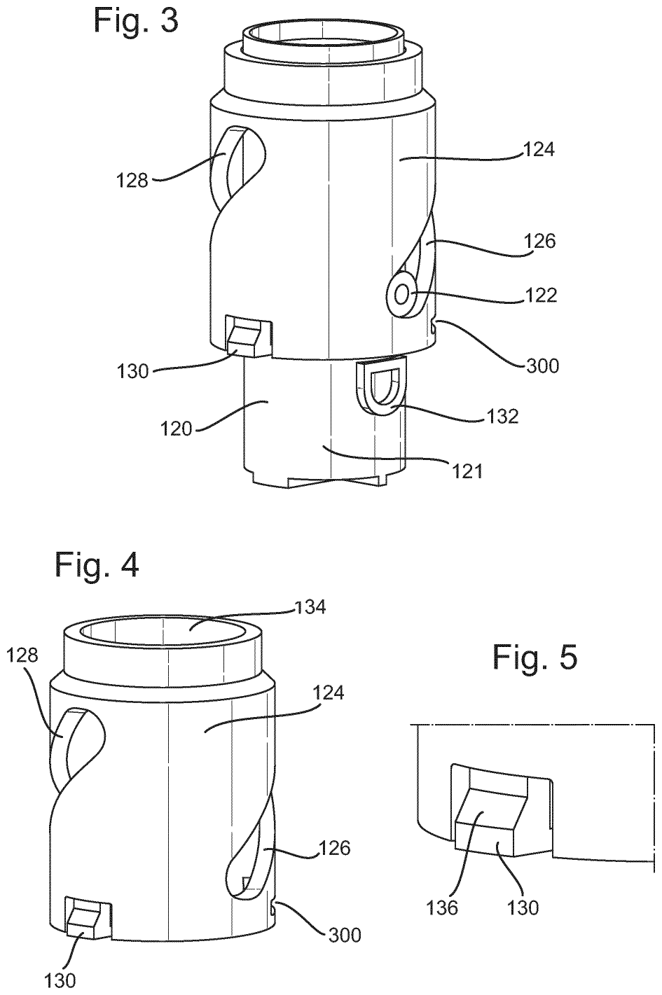

With reference to FIG. 3, the aerosol provision device 100 further comprises a rotatable tube 124 which may rotate relative to the main housing 105 and which is arranged to translate the receptacle 120 relative to the heater element 104. FIG. 3 shows a perspective view of the receptacle 120 assembled together with the rotatable tube 124.

The rotatable tube 124 may have a partial circumferential groove 300 which may engage with a corresponding projection (not shown) provided a tubular main housing 105 of the aerosol provision device 100. The partial circumferential groove 300 may extend, for example, 90° around the circumference at the bottom of the rotatable tube 124. It will be understood that the partial circumferential groove 300 may extend for a different proportion around the circumference.

Embodiments are also contemplated wherein the tubular main housing 105 may comprise a partial circumferential groove 300 and the rotatable tube 124 may comprise a projection which engages with the partial circumferential groove 300.

It will be understood that the rotatable tube 124 is able to rotate e.g. 90° relative to the main housing 105. As will be discussed in more detail below, as the rotatable tube 124 is rotated through 90° then projections 122,123 will rise up helical tracks 126, 128 with the result that the receptacle 120 will move linearly upwards and in a direction away from the heating element 104.

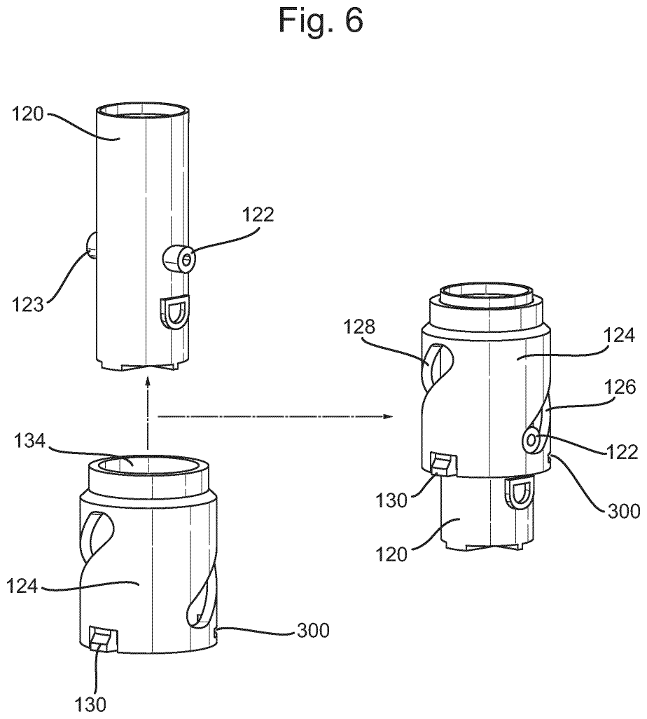

The receptacle 120 is arranged around a heating element 104 (see FIG. 2) which projects within the main housing 105. The receptacle 120 may receive an aerosol generating article (not shown) in use and the aerosol generating article may be forced onto the heating element 104 which may comprise a blade heating element. In an embodiment, the receptacle 120 comprises a first projection 122 and a second projection 123 (which is not shown in FIG. 3, but can be seen in FIG. 6). The first projection 122 and second projection 123 are external projections which extend away from an external surface 121 of the receptacle 120. The first projection 122 and second projection 123 may extend in a radial direction and thus each extend radially outwards.

The rotatable tube 124 may comprise a first helical track 126 and a second helical track 128. The first projection 122 engages the first helical track 126 and the second projection 123 engages the second helical track 128. Whilst the embodiment depicted comprises two projections 122,123 and two helical tracks 126,128, any number of projections and helical tracks may be provided. In the embodiment depicted, the first and second projections 122,123 are arranged on opposite sides of the receptacle 120 and the helical tracks 126,128 are located on opposite sides of the rotatable tube 124. However, the projections 122, 123 and corresponding helical tracks 126, 128 may be arranged in any suitable position such that their interaction drives translation of the receptacle 120 when the rotatable tube 124 is rotated.

In some embodiments, the first and second projections 122,123 may have a circular cross-sectional profile. Having a circular cross-sectional profile may ensure that the first and second projections 122, 123 travel smoothly within the corresponding helical tracks 126,128. However, the first and second projections 122,123 may have any cross-sectional profile which allows the projections 122,123 to travel within the helical tracks 126,128. In some embodiments, as depicted, the receptacle 120 is cylindrical and the rotatable tube 124 is also cylindrical. This may allow rotation of the rotatable tube 124 relative to the receptacle 120.

In some embodiments, the rotatable tube 124 may further comprise one or more retention elements 130. Whilst only one retention element 130 can be seen in FIG. 3, the rotatable tube 124 may comprise a second retention element 130 arranged on the opposite side of the rotatable tube 124. Any number of retention elements 130 may be provided on the rotatable tube 124. The one or more retention elements 130 may be used to secure the rotatable tube to a cover.

The receptacle 120 may further comprise one or more first alignment features 132. The first alignment features 132 do not extend sufficiently radially outwards so as to impede or prevent the receptacle 120 from moving linearly upwards inside the rotatable tube 124. The first alignment feature 132 will be discussed in more detail below with reference to FIG. 8.

When the rotatable tube 124 is rotated, engagement of the first and second projections 122,123 with the first and second helical tracks 126,128, respectively, will cause the receptacle 120 to translate relative to the rotatable tube 124. The helical tracks 126,128 act to convert the rotation of the rotatable tube 124 into linear translation of the receptacle 120.

The rotatable tube 124 is held in a fixed vertical position within the aerosol provision device 100. For example, the rotatable tube 124 may be attached a main housing 105 and may rotate around 90° relative to the main housing 105.

As a result, rotation of the rotatable tube 124 will cause translation of the receptacle 120 relative to the heating element 104. When an aerosol generating article is arranged in the receptacle 120, this translation may act to remove, e.g. separate, the aerosol generating article from the heating element 104. This simple action of rotating the rotatable tube 124 in order to remove an aerosol generating article from the aerosol provision device 100 may improve the ease of use of the aerosol provision device 100 for a user.

In some embodiments, the receptacle 120 may be translatable between a first position in which the receptacle 120 is fully advanced into the main housing 105 (i.e. the position the receptacle 120 is shown in FIG. 2 and FIG. 3) and a second position in which the receptacle 120 is at least partially advanced out of the main housing 105.

It will be understood, therefore, that the position of the receptacle 120 shown in FIG. 3 is such that the receptacle 120 is located fully downwards within the aerosol provision device 100 enabling an aerosol generating article to be fully inserted onto a heating element 104. When the rotatable tube 124 is then rotated, the receptacle 120 will move upwards relative to the main housing 105 with the result that a base portion 121 of the receptacle 120 will pull the aerosol generating article off the heating element 104. The receptacle 120 may, in some embodiments, be translated in a longitudinal direction relative to the aerosol provision device 100.

In some embodiments, when the receptacle is in the first position (wherein the receptacle 120 is fully advanced into the main housing 105) then a portion of the receptacle 120 may nonetheless protrude from the main housing 105. When the receptacle 120 is then moved into the second position, the receptacle 120 is advanced out of the main housing 105 and the receptacle 120 will protrude from the main housing 105 by an increased amount.

As discussed previously, the receptacle 120 may comprise a base portion 121 which comprises an aperture 119 through which heating element 104 projects. In some embodiments, when the receptacle 120 is moved from the first position to the second position, the base portion 121 of the receptacle may move towards the free end 107 of the heating element 104 (see FIG. 2). Moving towards the free end 107 of the heating element 104 may beneficially free the aerosol generating article from the heating element 104 thereby making it easier for a user to remove the aerosol generating article from the aerosol provision device 100.

In some embodiments, when the receptacle 120 is in the second position, the base portion 121 of the receptacle 120 may be past the free end 107 of the heating element 104. As such, any aerosol generating article within the receptacle 120 may become completely detached from the heating element 104. This may further facilitate the removal of the aerosol generating article from the aerosol provision device 100.

FIG. 4 shows a perspective view of the rotatable tube 124 in isolation. The rotatable tube 124 comprises a hollow core 134, through which the receptacle 120 extends in use. The first and second helical tracks 126,128 follow a helical profile but do not necessarily form a full helix. As depicted, each helical track 126,128 only extends around part of the circumference of the rotatable tube 124. The extent and form of the, or each, helical track 126,128 may depend on the amount of translation required of the receptacle 120, the amount of force which a user is able to apply to the rotatable tube 124, and/or the amount a user can feasibly rotate the rotatable tube 124.

FIG. 5 shows a view focused on the retention element 130 of the rotatable tube 124 described above. In some embodiments, the retention element 130 comprises a chamfered portion 136. The retention element 130 may be used to secure a tubular cover.

FIG. 6 illustrates the assembly of the rotatable tube 124 and receptacle 120. As shown, the receptacle 120 may first be inserted into the hollow core 134 of the rotatable tube 124. The width of the receptacle 120 at its widest point, i.e. where the first and second protrusions 122, 123 are arranged, may be wider than the hollow core 134 of the tube 124. As such, at least one of the rotatable tube 124 or receptacle 120 may be formed from a resiliently deformable material so as to allow the receptacle 120 to be inserted into the rotatable tube 124. As shown on the far right hand side of FIG. 6, when the receptacle 120 is fully inserted into the rotatable tube 124, the first and second protrusions 122, 123 will engage the respective first and second helical tracks 126,128.

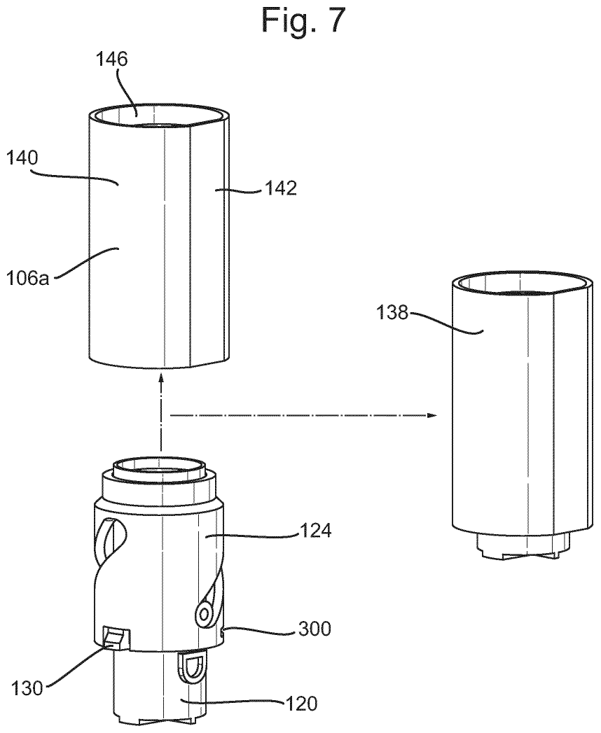

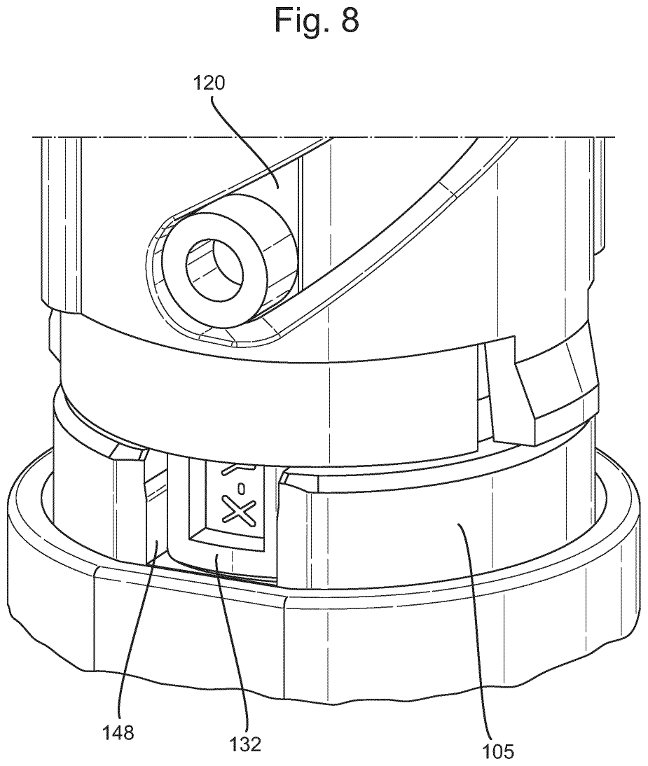

The aerosol provision device 100 may further comprise a cap or tubular cover 106a as shown in FIG. 7. The cap or tubular cover 106a may be attached to the rotatable tube 124 with the receptacle 120 arranged therein. The rotatable tube 124 and the receptacle 120 may be inserted into the hollow core of the cap or tubular cover 106a. In some embodiments, as depicted, the cap or tubular cover 106a may be sleeved onto the rotatable tube 124. The cap or tubular cover 106a may engage the rotatable tube 124 such that rotation of the cap or tubular cover 106a drives rotation of the rotatable tube 124, which causes translation of the receptacle 120. The cap or tubular cover 106a may be secured to the retention element(s) 130 provided on the rotatable tube 124.

According to an embodiment the cap or tubular cover 106a is arranged to engage the rotatable tube 124 such that, in use, rotation of the cap or tubular cover 106a drives rotation of the rotatable tube 124. The receptacle 120 may be translatable between a first position in which the receptacle 120 is fully contained within the cap or tubular cover 106a, and a second position in which the receptacle 120 protrudes from an open end of the cap or tubular cover 106a.

In some embodiments, the receptacle 120 may be translatable between a first position as shown in FIG. 7 in which the receptacle 120 is fully contained within the cap or tubular cover 106a to a second position in which the receptacle 120 protrudes from an open end 146 of the cap or tubular cover 106a. As such, it may be possible to remove the aerosol generating article contained within the receptacle 120 without removing the cap or tubular cover 106a. This may further improve the ease of use of the aerosol provision device 100.

With reference to FIG. 7, in some embodiments, the cap or tubular cover 106a may comprise a truncated circular cross-sectional profile comprising a first arcuate section having a curved outer surface 140 and a second linear section having a planar outer surface 142. The planar outer surface 142 may allow a user to achieve an improved grip on the cap or tubular cover 106a, thereby allowing the user to rotate the cap or tubular cover 106a more easily. In some embodiments, the cap or tubular cover 106a may comprise alternative gripping means which facilitate improved grip by a user.

With reference to FIG. 8, in some embodiments, the receptacle 120 comprises at least one first alignment feature 132. In some embodiments, the first alignment feature 132 may be in the form of an alignment protrusion which extends externally of the receptacle 120. The first alignment feature 132 may extend radially outwards from the receptacle 120. The first alignment feature 132 may be arranged to engage a second alignment feature 148 arranged on the main housing 105. In some embodiments, the second alignment feature 148 may be in the form of a cut-away in the main housing 105 which is shaped to receive the first alignment feature 132. Any suitable first alignment feature 132 and second alignment feature 148 may be utilized. Whilst the first alignment feature 132 is shown in the form of a protrusion and the second alignment feature 148 is shown in the form of a cut-away, this arrangement may be reversed, or indeed any other suitable arrangement may be used.

In some embodiments, the first alignment feature 132 may engage with the second alignment feature 148 when the receptacle 120 is fully advanced into the main housing 105. It is envisaged, however, that the first alignment feature 132 and second alignment feature 148 may be arranged in any other suitable position such that they engage at any other appropriate position of the receptacle 120 relative to the main housing 105. Engagement of the first alignment feature 132 and second alignment feature 148 may help to ensure that the components of the aerosol provision device 100 are aligned and assembled in the correct orientation. The first alignment feature 132 may disengage the second alignment feature 148 when the receptacle 120 is translated out of the fully advanced position shown in FIG. 8. The first alignment feature may reengage the second alignment feature 148 when the receptacle 120 is moved back into the fully advanced position shown in FIG. 8. The first and second alignment features 132, 148 may not necessarily contact one another when engaged. Instead, the first alignment feature 132 may sit within, but without contacting, the second alignment feature 148.

Whilst in the embodiments discussed above the one or more projections are arranged on the receptacle and the one or more helical tracks are arranged on the rotatable tube, it will be appreciated that this arrangement may be reversed such that the one or more projections are arranged on the rotatable tube and the one or more helical tracks are arranged on the receptacle.

According to various embodiments an aerosol provision device 100 is disclosed having a rotatable tube 124. The rotatable tube 124 may be rotated relative to a main housing 105 and the rotational movement of the rotatable tube 124 may be converted into linear movement of a receptacle 120. The receptacle 120 comprises a base portion 121 having an aperture 119 and wherein a heating element 104 projects through the aperture 119. An aerosol generating article may be secured onto the heating element 104. When the receptacle 120 is moved upwards due to rotation of the rotatable tube 124, then the receptacle 120 may cause the aerosol generating article to be pulled off the heating element 104.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a main housing comprising a heating element which projects within the main housing;
a receptacle arranged around the heating element and arranged to receive an aerosol generating article, the receptacle having one or more external projections; and
a rotatable tube having one or more helical tracks, wherein the one or more projections on the receptacle engage with the one or more helical tracks, and wherein in use the rotatable tube may be rotated in order to translate the receptacle relative to the heating element so as to remove or at least partially remove an aerosol generating article from the heating element.

2. An aerosol provision device as claimed in claim 1, wherein the receptacle is translatable between a first position in which the receptacle is fully advanced into the main housing and a second position in which the receptacle is at least partially advanced out of the main housing.

3. An aerosol provision device as claimed in claim 2, wherein the receptacle comprises a base portion comprising an aperture through which heating element passes and wherein when moving from the first position to the second position the base portion of the receptacle moves towards a free end of the heating element.

4. An aerosol provision device as claimed in claim 3, wherein in the second position the base portion of the receptacle is past the free end of the heating element.

5. An aerosol provision device as claimed in claim 1, further comprising a tubular cover arranged to cover the rotatable tube, and wherein the tubular cover is arranged to engage the rotatable tube such that, in use, rotation of the tubular cover drives rotation of the rotatable tube.

6. An aerosol provision device as claimed in claim 5, wherein the receptacle is translatable between a first position in which the receptacle is fully contained within the tubular cover and a second position in which the receptacle protrudes from an open end of the tubular cover.

7. An aerosol provision device as claimed in claim 5, wherein the tubular cover is configured to be sleeved onto the rotatable tube.

8. An aerosol provision device as claimed in claim 5, wherein the tubular cover has a truncated circular cross-sectional profile comprising a first arcuate section having a curved outer surface and a second linear section having a planar outer surface.

9. An aerosol provision device as claimed in claim 1, wherein the receptacle is translatable in a longitudinal direction of the aerosol provision device.

10. An aerosol provision device as claimed in claim 1, wherein an outer dimension of the receptacle substantially corresponds to an inner dimension of the rotatable tube.

11. An aerosol provision device as claimed in claim 1, wherein the one or more projections comprise a first projection and a second projection, wherein the one or more helical tracks comprise a first helical track and a second helical track, and wherein the first projection is arranged to engage with the first helical track and the second projection is arranged to engage with the second helical track.

12. An aerosol provision device as claimed in claim 11, wherein the second projection is located on an opposite side of the receptacle to the first projection.

13. An aerosol provision device as claimed in claim 1, wherein the one or more projections each comprise a circular cross-sectional profile.

14. An aerosol provision device as claimed in claim 1, wherein the receptacle is cylindrical and wherein the rotatable tube is cylindrical.

15. An aerosol provision device as claimed in claim 1, wherein the rotatable tube comprises one or more retention elements arranged to engage a tubular cover arranged to cover the rotatable tube.

16. An aerosol provision device as claimed in claim 15, wherein each of the one or more retention elements are resiliently biased such that they engage the tubular cover.

17. An aerosol provision device as claimed in claim 15, wherein each of the one or more retention elements comprises a chamfered portion arranged to allow the tubular cover to pass over the retention element during assembly of the aerosol provision device.

18. An aerosol provision device as claimed in claim 1, wherein the receptacle comprises a first alignment feature and the main housing comprises a second alignment feature, and wherein the first alignment feature is arranged to engage the second alignment feature.

19. An aerosol provision device as claimed in claim 18, wherein the first alignment feature is arranged to engage the second alignment feature when the receptacle is fully advanced into the main housing.

20. An aerosol provision device as claimed in claim 18, wherein one of the first alignment feature or second alignment feature comprises an alignment protrusion and wherein the other of the first alignment feature or second alignment feature comprises a cut-away shaped to receive the alignment protrusion.

21. An aerosol provision system comprising:
an aerosol provision device according to claim 1; and
an aerosol generating article for insertion into the aerosol provision device.
